(19) United States
(12) Patent Application Publication
(10) Pub. No.: US 2015/0354276 A1
(43) Pub. Date: Dec. 10, 2015

(54) COLLAPSIBLE LADDER

(71) Applicant: LOCK N CLIMB, LLC, Bartlesville, OK (US)

(72) Inventor: JEFFREY A. GREEN, Bartlesville, OK (US)

(21) Appl. No.: 14/716,043

(22) Filed: May 19, 2015

Related U.S. Application Data
(60) Provisional application No. 62/000,440, filed on May 19, 2014.

(51) Int. Cl. E06C 1/16

(52) U.S. Cl. CPC E06C 1/16

(57) ABSTRACT

The present invention is directed to a collapsible ladder system comprising a first ladder rail and a second ladder rail connected by a plurality of rungs, a base rail assembly comprising a first base rail pivotably connected to both the first ladder rail and a lower support brace, wherein the lower support brace is pivotably connected to an upper support brace that is pivotably connected to the first ladder rail, a second base rail pivotably connected to both the second ladder rail and a lower support brace, wherein the lower support brace is pivotably connected to an upper support brace that is pivotably connected to the second ladder rail.

### TECHNICAL FIELD

The present invention is directed to a collapsible ladder system comprising a first ladder rail and a second ladder rail connected by a plurality of rungs, a base rail assembly comprising a first base rail pivotably connected to both the first ladder rail and a lower support brace, wherein the lower support brace is pivotably connected to an upper support brace that is pivotably connected to the first ladder rail, a second base rail pivotably connected to both the second ladder rail and a lower support brace, wherein the lower support brace is pivotably connected to an upper support brace that is pivotably connected to the second ladder rail.

### BACKGROUND

Ladders have the problem that when in use, they are generally unstable. This lack of stability will often lead to injury or even death. Indeed, injuries related to ladder use are a leading problem in construction, repair and other industries. Until now, the most common way to remedy an unstable ladder was to require a second person to be positioned at the base of the ladder, or to construct a form of scaffolding, which is both costly and time-consuming.

Numerous modifications have been made to ladders over the years, including, for example, U.S. Pat. No. 202,426; 281,977; 515,783; 886,737; 1,812,119; 1,811,722; 2,007,057; 2,471,110; 2,584,197; 2,887,260; 2,934,163; 3,288,248; 3,374,860; 4,520,896; 4,565,262; 4,669,576; 5,033,584; 5,086,876; 5,165,501; 5,590,739 and U.S. Publication Number 2010/0147623. However, a need still exists for an easy-to-use, collapsible multi-surface, self-supporting ladder and collapsible ladder system 100 with increased stability that does not require a second person or unnecessary assembly time. One aspect of the present disclosure is to provide a configuration that will help prevent injuries for individuals who climb, work on, dismount from or do any other work involving a ladder.

### SUMMARY

The present disclosure endeavors to provide a compact collapsible self-supporting ladder and collapsible ladder system with an increased stability that is capable of being used against a structure.

In a first embodiment, the present invention is directed to a collapsible ladder system comprising a first ladder rail and a second ladder rail connected by a plurality of rungs, a base rail assembly comprising a first base rail pivotably connected to both the first ladder rail and a lower support brace, wherein the lower support brace is pivotably connected to an upper support brace that is pivotably connected to the first ladder rail, a second base rail pivotably connected to both the second ladder rail and a lower support brace, wherein the lower support brace is pivotably connected to an upper support brace that is pivotably connected to the second ladder rail.

In some embodiments, the base rail assembly is configured to collapse into a plane substantially parallel to a plane formed by the first and second ladder rails. In some embodiments, the base rail assembly further comprises a brace lock disposed on the upper or lower support brace, the brace lock configured to releasably engage the upper or lower support braces to inhibit the rotation about a point where the upper and lower support braces are connected. In some embodiments, the brace lock further comprises a sliding sleeve configured to inhibit the brace lock from disengaging. In some embodiments, the base rail assembly further comprises a support rod connected to the first and second base rails and disposed to lie substantially perpendicular to the first and second base rails. In some embodiments, the base rail assembly further comprises a gripping material connected to the first or second base rail.

In a second embodiment, the present invention is directed to a base rail assembly for a ladder comprising a first base rail pivotably connected a lower support brace that is pivotably connected to an upper support brace, a second base rail pivotably connected a lower support brace that is pivotably connected to an upper support brace, wherein the base rail assembly is pivotably connected to the ladder.

In some embodiments, the base rail assembly is configured to collapse into a plane substantially parallel to a plane of the ladder. In some embodiments the base rail assembly further comprises a brace lock disposed on the upper or lower support brace, the brace lock configured to releasably engage the upper or lower support braces to inhibit the rotation about a point where the upper and lower support braces are connected. In some embodiments, the brace lock further comprises a sliding sleeve configured to inhibit the brace lock from disengaging. In some embodiments the base rail assembly further comprises a support rod connected to the first and second base rails and disposed to lie substantially perpendicular to the first and second base rails. In some embodiments, the base rail assembly further comprises a gripping material connected to the first or second base rail. In some embodiments, the base rail assembly is connected to a rail of the ladder through a plurality of pivotable connectors. In some embodiments, the base rail assembly is connected to the ladder through a pivotable connector disposed through the inside of one or more rungs of the ladder.

In a third embodiment, the present invention is directed to a method of securing a collapsible ladder system comprising: (i) providing a collapsible ladder system comprising a first ladder rail and a second ladder rail connected by a plurality of rungs, and a base rail assembly comprising a first base rail pivotably connected to both the first ladder rail and a lower support brace, wherein the lower support brace is pivotably connected to an upper support brace that is pivotably connected to the first ladder rail, and a second base rail pivotably connected to both the second ladder rail and a lower support brace, wherein the lower support brace is pivotably connected to an upper support brace that is pivotably connected to the second ladder rail, and (ii) pivoting the base rail assembly into a position wherein the first and second base rails are in substantial contact with the ground, and (iii) securing the collapsible ladder system by engaging a brace lock disposed on the upper or lower support brace, the brace lock configured to releasably engage the upper or lower support braces to inhibit the rotation about a point where the upper and lower support braces are connected. In some embodiments, the method further comprises the step of (iv) engaging a sliding sleeve configured to inhibit the brace lock from disengaging.

### BRIEF DESCRIPTION OF THE DRAWINGS

These and other advantages of the present invention will be readily understood with reference to the following specifications and attached drawings wherein:

FIGS. 1, 2, 3, 4A, 4B, 5A, 5B, 8A, and 13A depict a collapsible ladder system 100 of the present invention in the fully extended (non-collapsed) position;

FIGS. 6A, 6B, 7A, 7B, 12A, 12B, and 14B depict a collapsible ladder system 100 in a folded (collapsed) position; and

FIGS. 8B, 9A, 9B, 10A, 10B, 11A, 11B, 13B and 14A depict a collapsible ladder system 100, being transitioned from a fully extended (non-collapsed) position to a folded (collapsed) position.

### DETAILED DESCRIPTION

Preferred embodiments of the present invention will be described herein below with references to the accompanying drawings. In the following description, well-known functions or constructions are not described in detail, since such minutia would obscure the invention in unnecessary trivia.

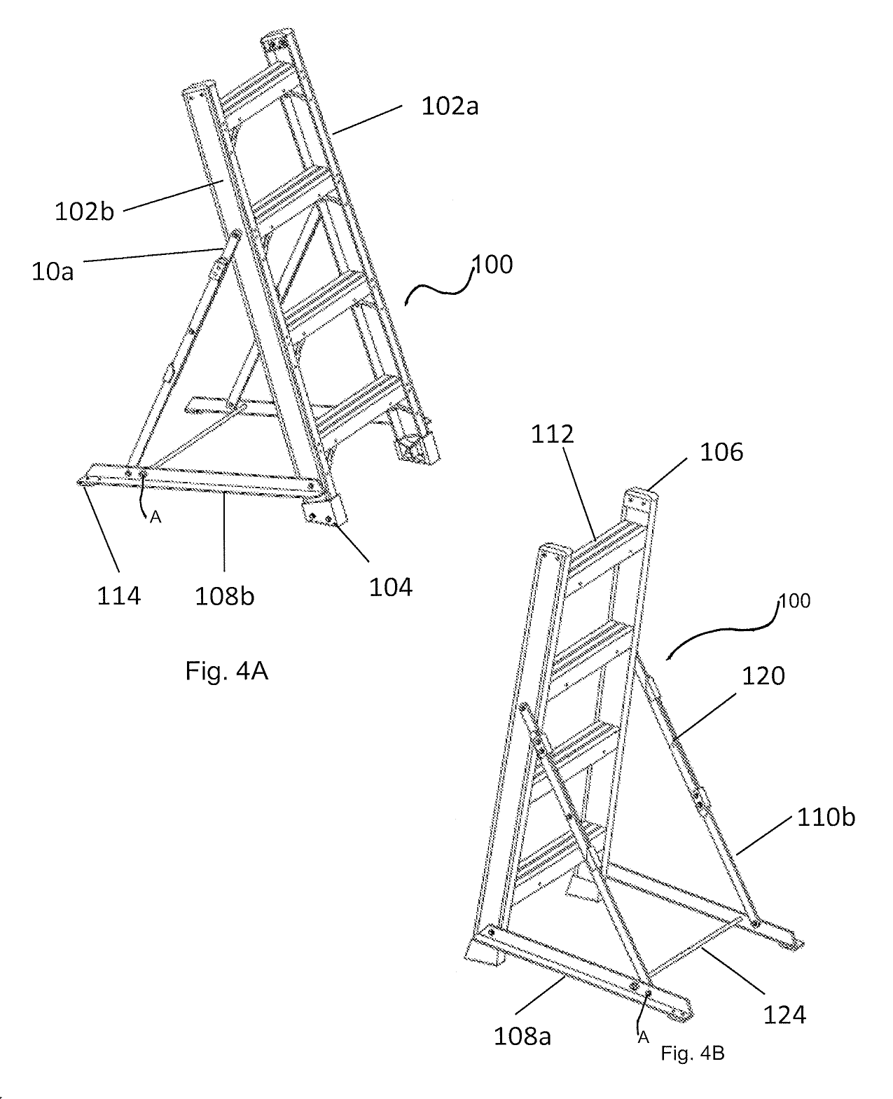

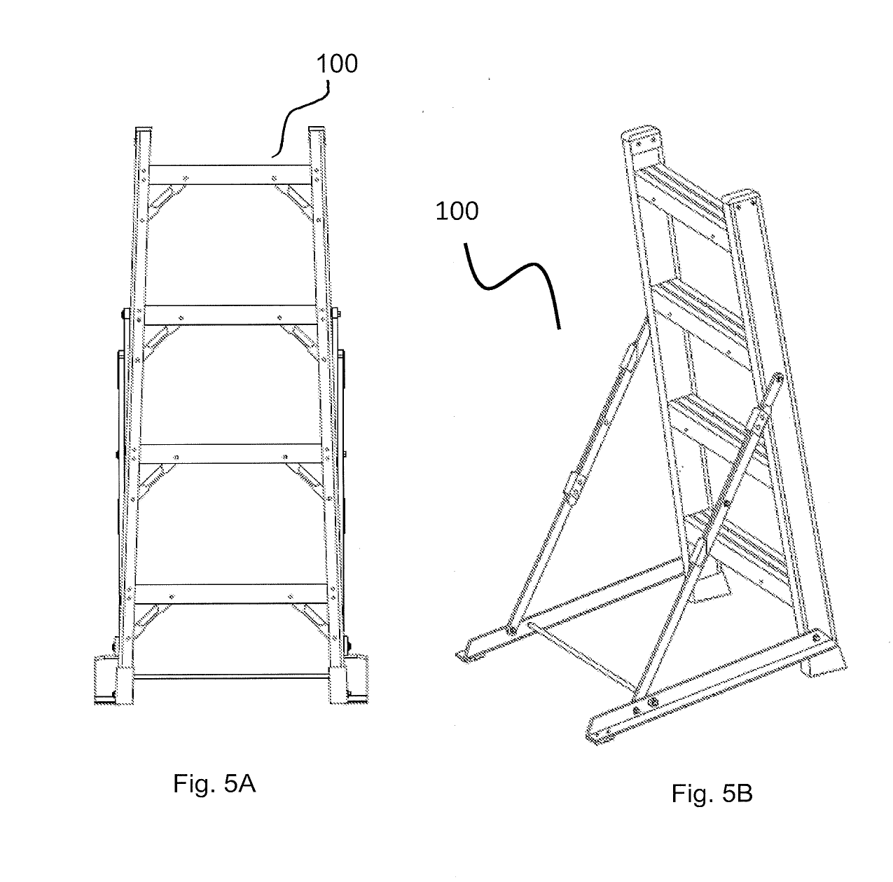

Referring now to the Figures, a collapsible ladder system 100 is shown in a fully extended position. As illustrated in FIGS. 4A and 4B, a collapsible ladder system 100 may generally comprise a pair of ladder rails 102a, 102b, a pair of base rails 108a, 108b, an upper support brace 110a, a lower support brace 110b, and a plurality of a rungs 112 (e.g., hollow ladder rungs, as a D-Rung) joining the inner surface of a first ladder rail 102a to the inner surface of the second ladder rail 102b and disposed to lie generally perpendicular to said first and second ladder rails 102a, 102b. The rungs 112 may be hollow, solid, or formed into a step from sheet metal. The rungs 112 may further comprise a gripping surface to increase traction between the rungs 112 and the user foot or shoe cover.

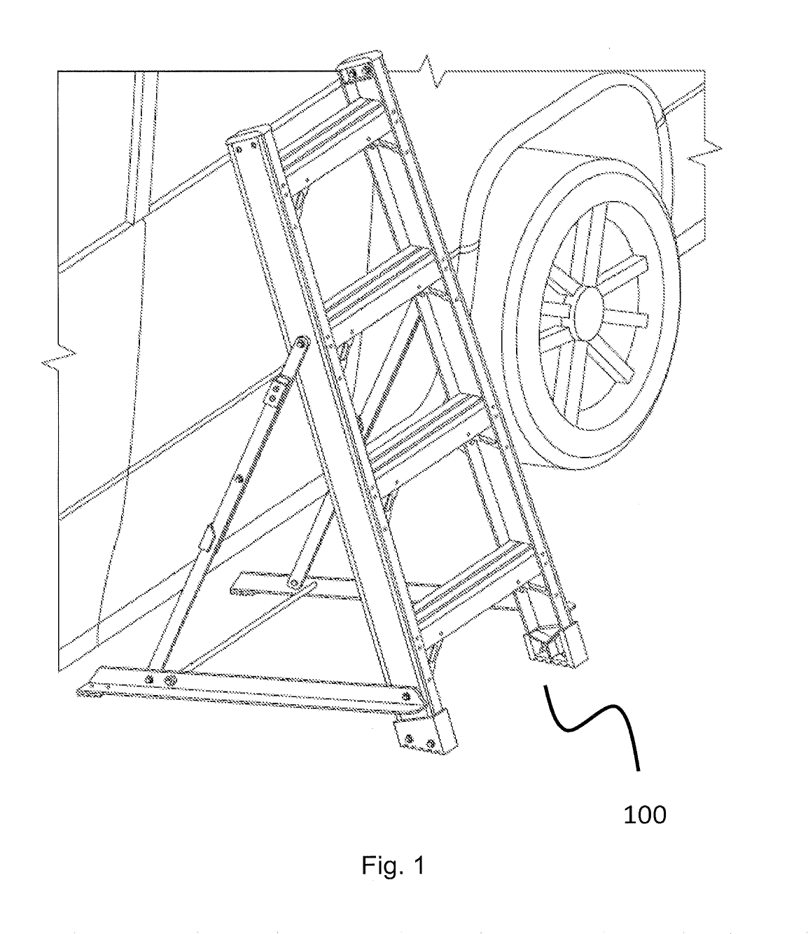

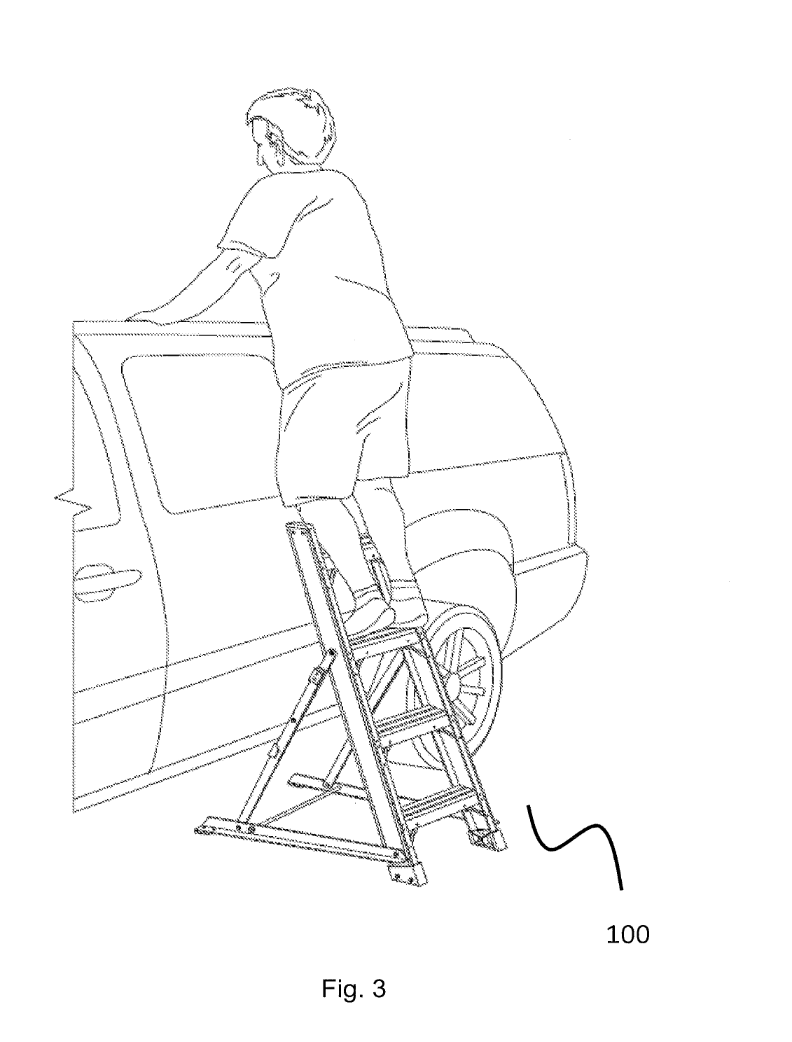

The construction of the collapsible ladder system 100 enables the collapsible ladder system 100 to be placed against a structure while ensuring the user is able to work on the structure without leaning, thereby increasing safety. For example, as illustrated in FIGS. 1 through 3, the collapsible ladder system 100 may be placed against a vehicle while enabling the user to access the vehicle without having to lean forward. While the collapsible ladder system 100 may be manufactured as a complete system, the it is possible to adapt a base rail assembly comprising the pair of base rails 108a, 108b and the pair of support braces 110a, 110b to existing ladders so as to provide a retrofit option. For example, in certain situations, it may be advantageous to removably attach the support braces 110a, 110b and/or pair of base rails to an existing ladder without drilling or otherwise modifying the original ladder structure. In fact, certain ladder manufactures may prohibit the drilling of holes though a ladder rail alleging that it could weaken the structural integrity of the ladder. While this may not necessarily be true, the ladder manufacturer may nevertheless void the warranty. Therefore, to circumvent the risk of voiding a manufacturer warranty, a user may wish to safely attach a collapsible ladder system 100 without requiring any modifications to the original ladder. This may be accomplished by, for instance, inserting a rod, bolt or other part configured to connect the component parts of the base rail assembly through a hollow rung of a ladder (e.g., D-rung). In order to receive a nut, the rod may be threaded at the distal ends or, in the alternative, threaded across the entire length of the rod. In order to reduce friction and/or prevent the rod from becoming misaligned during use, a bushing may be inserted on each end of the rod.

In certain aspects, the ladder rails 102a, 102b are substantially parallel, as illustrated, however the ladder rails 102a, 102b may be outwardly flared at their lower ends to provide a wider stance, thereby increasing stability. Regardless, each of the ladder rails 102a, 102b may have a foot 104 located at the end of the ladder rail 102a, 102b where contact is made with the ground, referred to hereinafter as the ground contact point, while the opposite end of each of the ladder rail 102a, 102b may comprise a cap 106.

The feet 104, located at the end of the ladder rails 102a, 102b at the ground contact point, may be angularly and/or vertically adjustable. For example, each of said feet 104 may comprise a vertically extendable shaft and shoe pivotablely connected to the shaft using a pivotable connector. The pivotable connector allows the foot 104's shoe to conform to the angle of the ground on which it is placed. If required, the pivotable connector may be tightened, therefore locking the shoe in the preferred arrangement (e.g., a desired angle). The underside of the shoe may include a gripping material to minimize slippage at the ground contact point. Depending on the application, said gripping material could be a rubber pad for use on a relatively smooth hard surface, spiked, or staggered for use on grass and packed dirt, or even a planar foot that creates a large shoe surface area, therefore preventing the foot 104 from sinking into soft ground. Depending on the choice of shoe, the collapsible ladder system 100 may be used on ground surfaces such as concrete, dirt, steel, tile, grating, brick, stone and most floor materials. The pivotable connector between the shaft and shoe may be permanent or removable, therefore allowing one to interchange the shoe depending on the application or environment.

In certain aspects, the foot 104 may comprise on or more wheels (e.g., a spring loaded caster, which may employ a load related locking effect). For example, spring loaded castors, which may be swivel and rigidly mounted, enable the collapsible ladder system 100 to roll when weight is not applied, but upon adding weight (e.g., the user climbing onto a rung), the spring will depress causing the wheel to reside within the foot 104 such that the collapsible ladder system 100 is unable to roll. For example, to protect younger or lightweight users, the spring loaded castors may begin to depress upon being loaded with a 10 pound load, and to fully compress upon being loaded with a 20 pound load. The cap 106 may be padded so as to prevent damage to a structure. The cap 106 may even facilitate coupling with a structure (e.g., a tie off).

A pair of base rails 108a, 108b may be pivotablely connected at one end to an end of corresponding ladder rails 102a, 102b. That is, for example, a first end of a base rail 108a may pivotablely couple to ladder rail 102a at, or near, the ground contact point (e.g., just above the foot 104, as illustrated). Similarly, as illustrated, a first end of a base rail 108b may be pivotablely coupled to ladder rail 102b at, or near, the ground contact point. As discussed with regard to the shoe, the second end of base rail 108a may comprise a gripping material 114 to minimize slippage between the base rails 108a, 108b and the ground at the ground contact point. As illustrated, to increase rigidity while ensuring light design the pair of base rails 108a, 108b may be fabricated in the shape of an angle “L” bar. However, other shapes are possible, including, “T” or “I”-shaped rails, quadrilateral rails (e.g., rectangular or square tubing or solid rails), etc.

An upper support brace 110a and lower support brace 110b may be pivotablely connected at one end to an end of corresponding ladder rails 102a, 102b and, at the other end, to the pair of base rails 108a, 108b. That is, for example, a first end of upper support brace 110a may pivotablely couple to ladder rail 102a between the midpoint of the ladder rail 102a's length and the ground contact points (e.g., about ⅔ the distance from the ground contact point to the other distal end—the cap 106 end), while the end of lower support brace 110b may pivotablely couple to base rail 108a at, or near, the second end of base rail 108a. The upper and lower support braces 110a, 110b may be either permanently connected to the ladder rails 102a, 102b and/or pair of base rails 108a, 108b by means of a bolt, rivet, pivoting hinge, etc. or alternatively, the pivotable connection may be removably attached by means of, for example, a clamping structure, allowing the collapsible ladder system 100 to be used on a multitude of preexisting ladders.

The upper and lower support braces 110a, 110b may generally comprise rigid spans that are pivotablely connected at a point 120 (FIG. 4B). Further, each rigid span may comprise a brace lock such that, when in the extended position (i.e., the support brace 110a, 110b is substantially straight), the brace lock of an upper support brace rigid span abuts a portion of the lower support brace rigid span, while the brace lock of the lower support brace rigid span abuts a portion of the upper support brace rigid span, thereby locking the upper and lower support braces 110a, 110b in the extended (straight) position. That is, the rigid spans of each support brace are prohibited from pivoting beyond a particular point (i.e., beyond the substantially straight position). In some embodiments, the brace lock is configured to releasably engage the upper or lower support braces to inhibit the rotation about a point where the upper and lower support braces are connected. In some embodiments, the brace lock further comprises a sliding sleeve configured to inhibit the brace lock from disengaging from the support braces, providing additional strength and reliability to the ladder system.

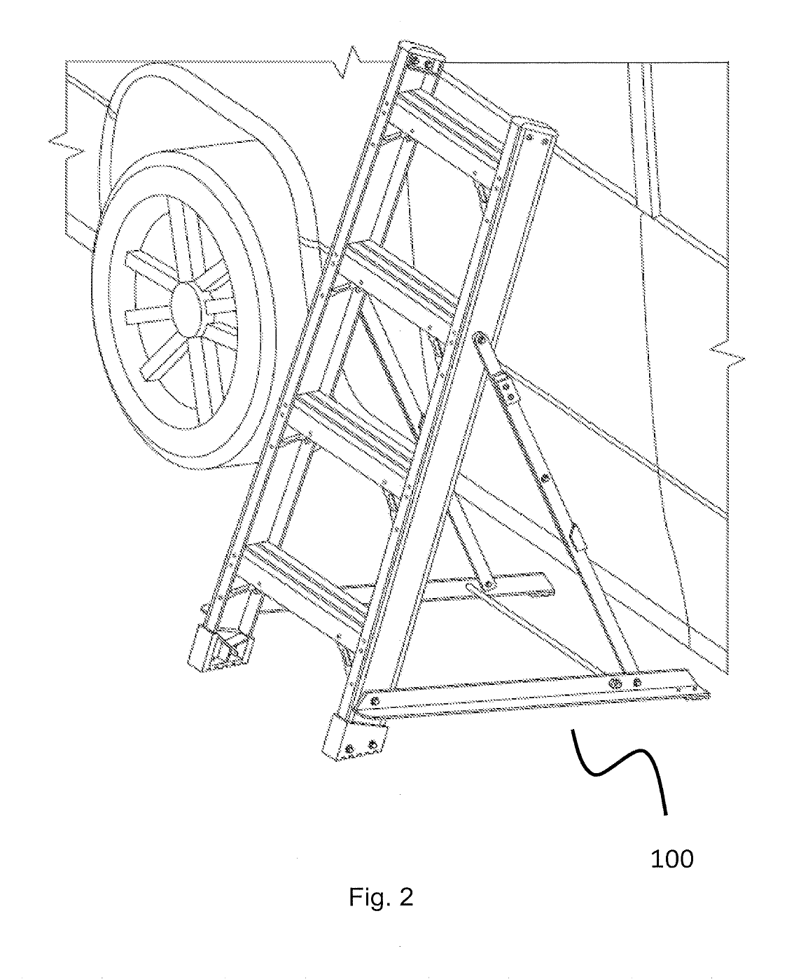

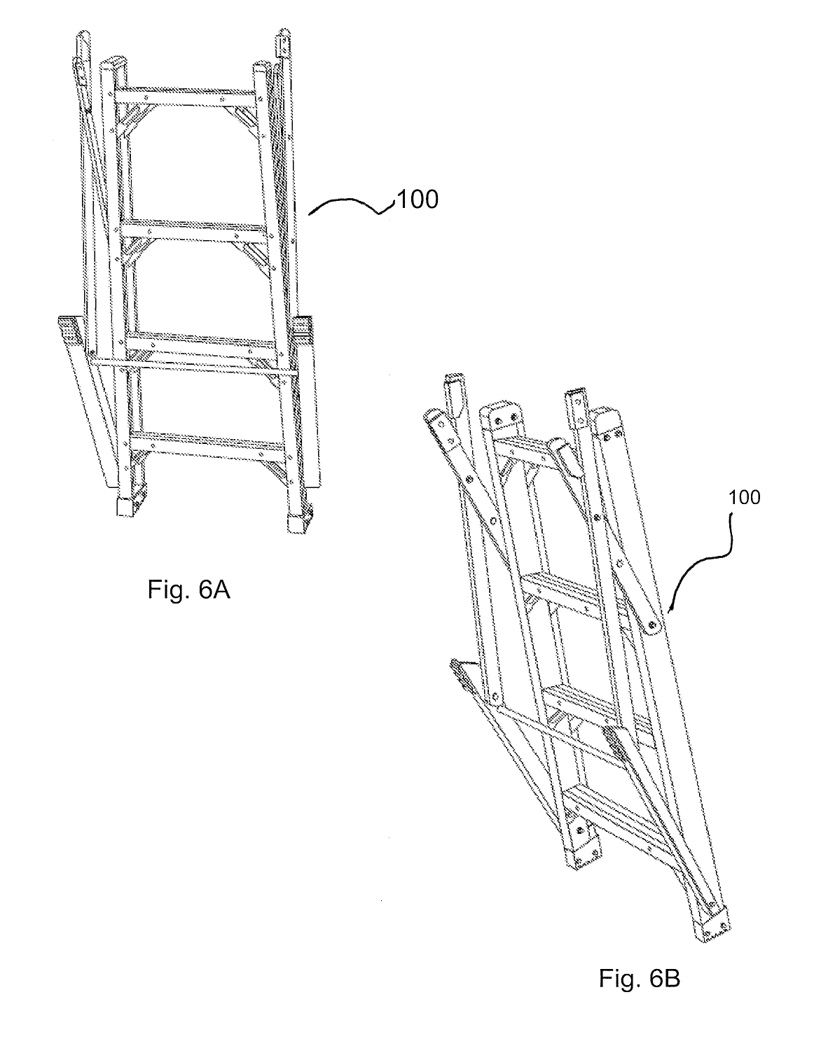

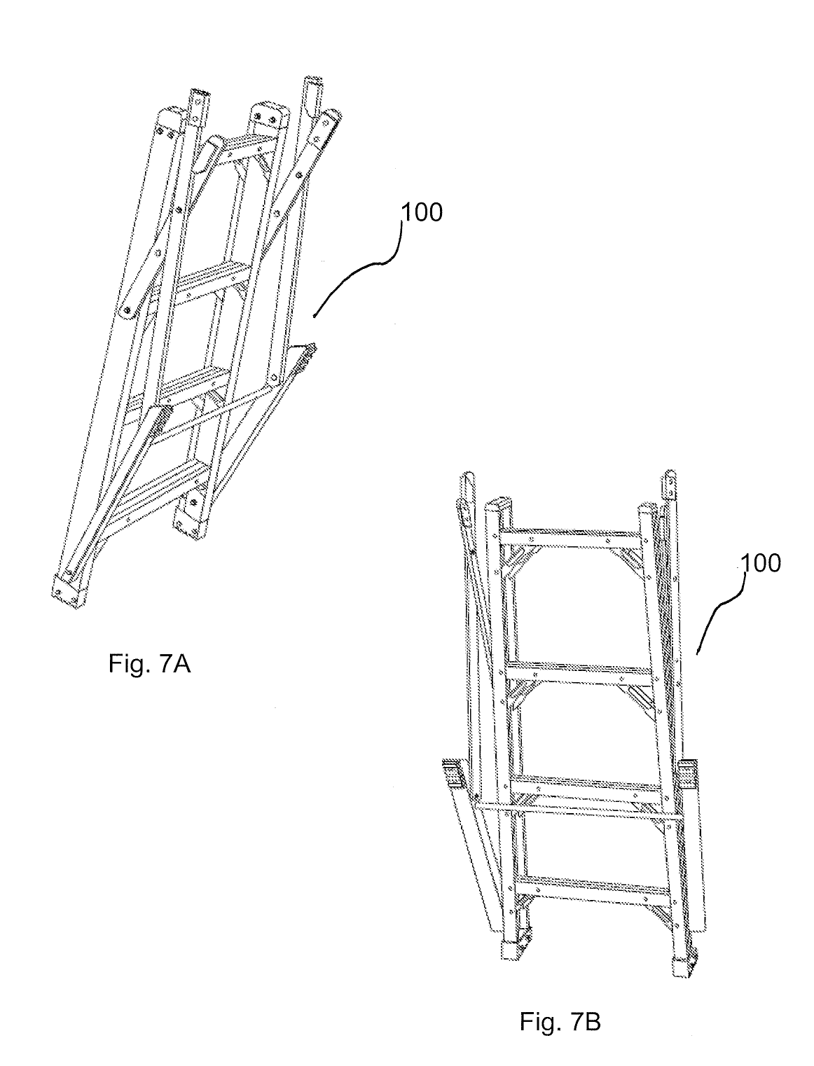

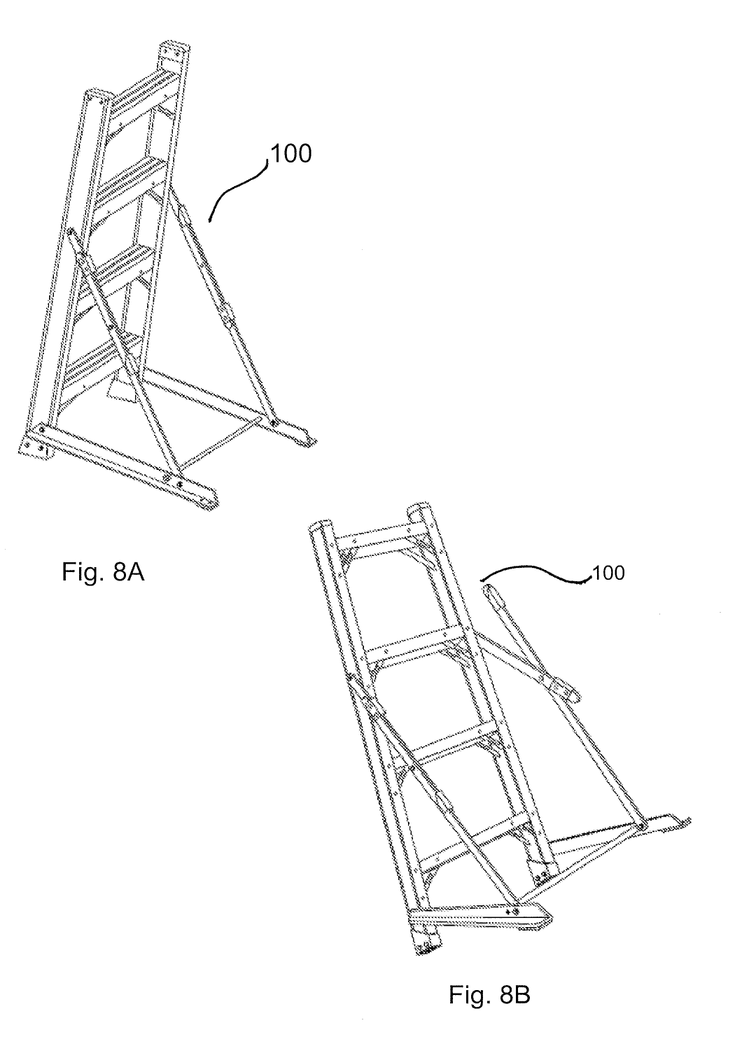

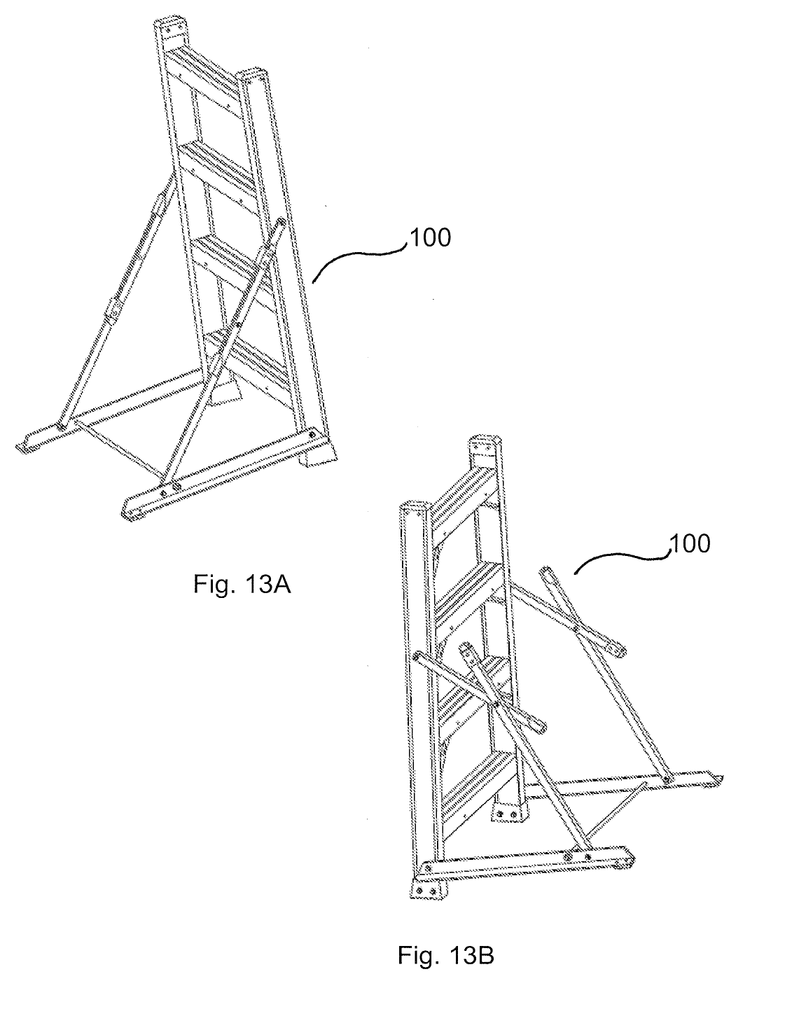

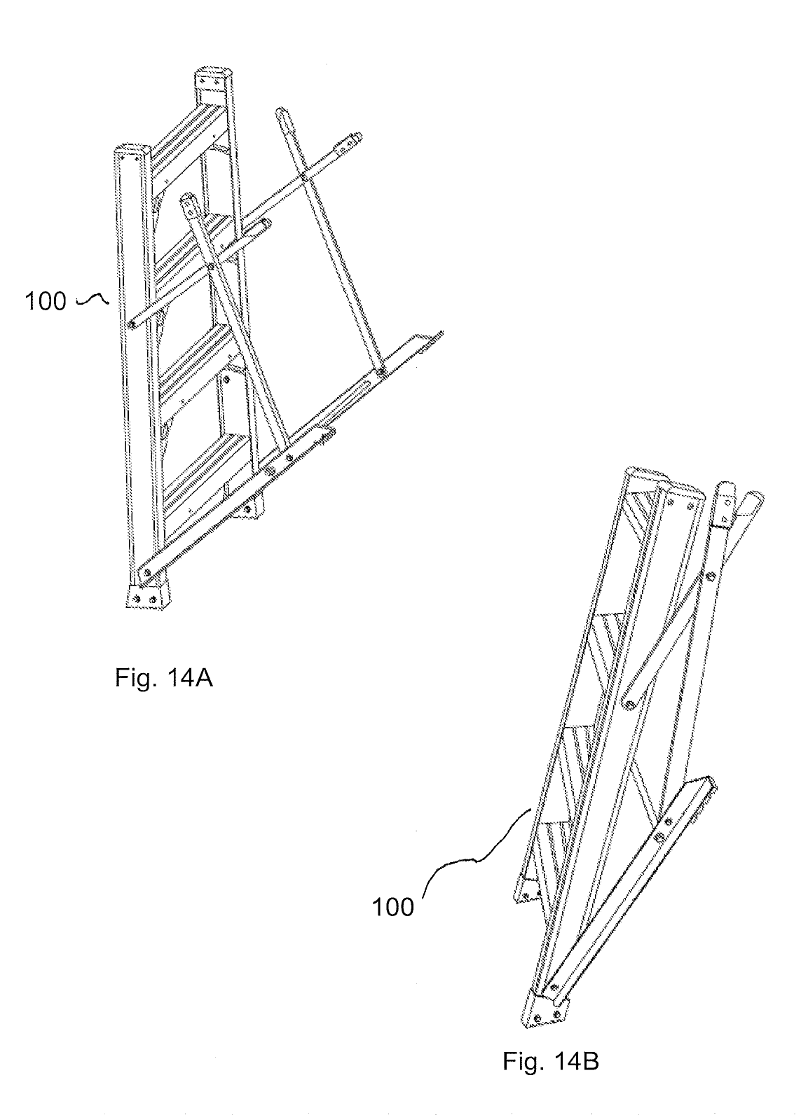

Referring now to FIGS. 6A through 14B, the steps for collapsing the collapsible ladder system 100 are provided. FIG. 2 illustrates the collapsible ladder system 100 in a fully extended (non-collapsed) position.

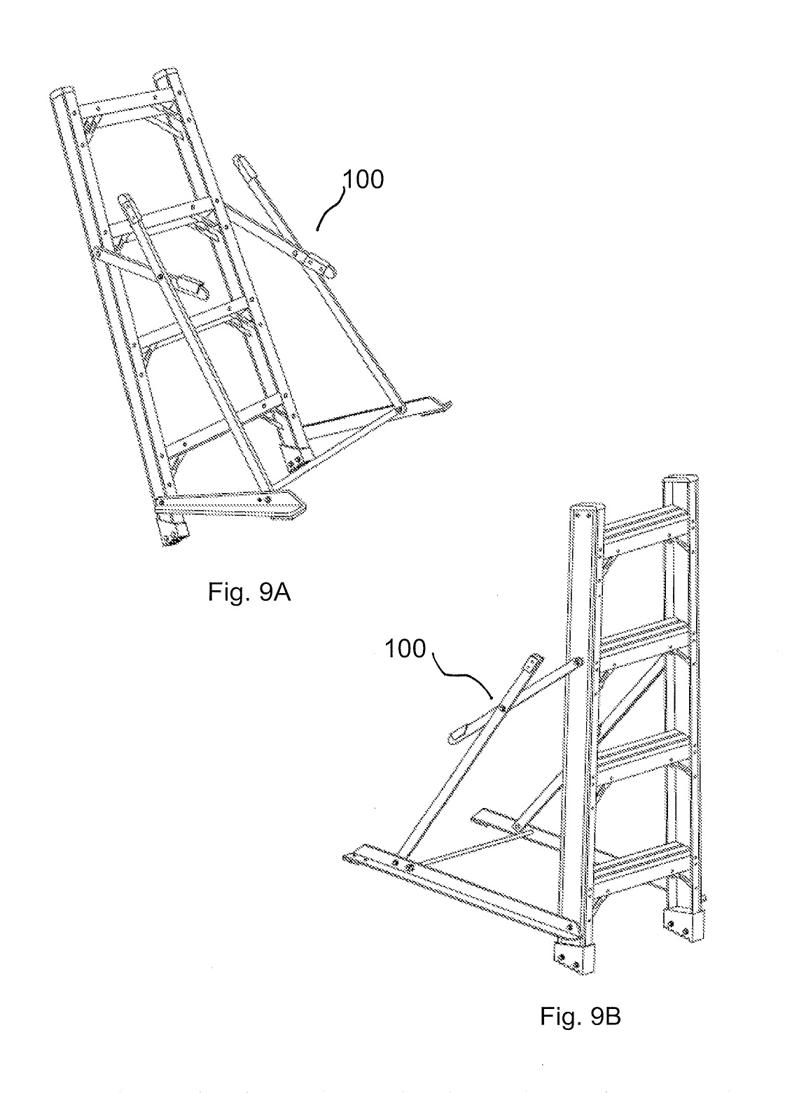

FIG. 9A illustrates the collapsible ladder system 100 with the first brace in a partially collapsed (partially folded) position. That is, the brace lock is no longer lock and/or abutting.

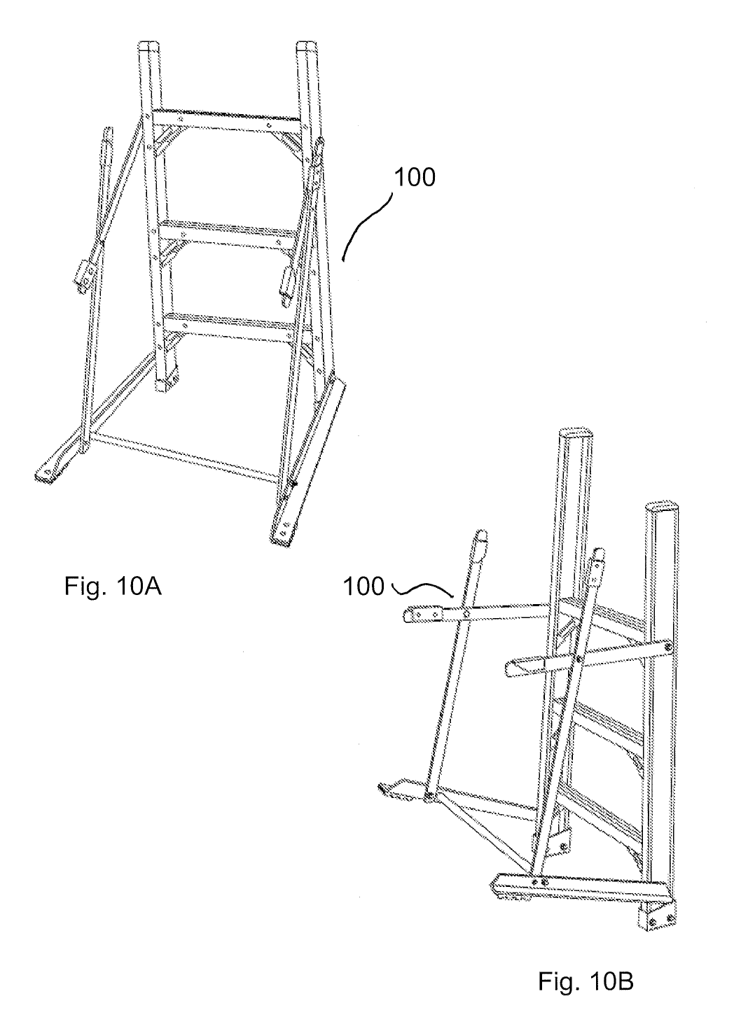

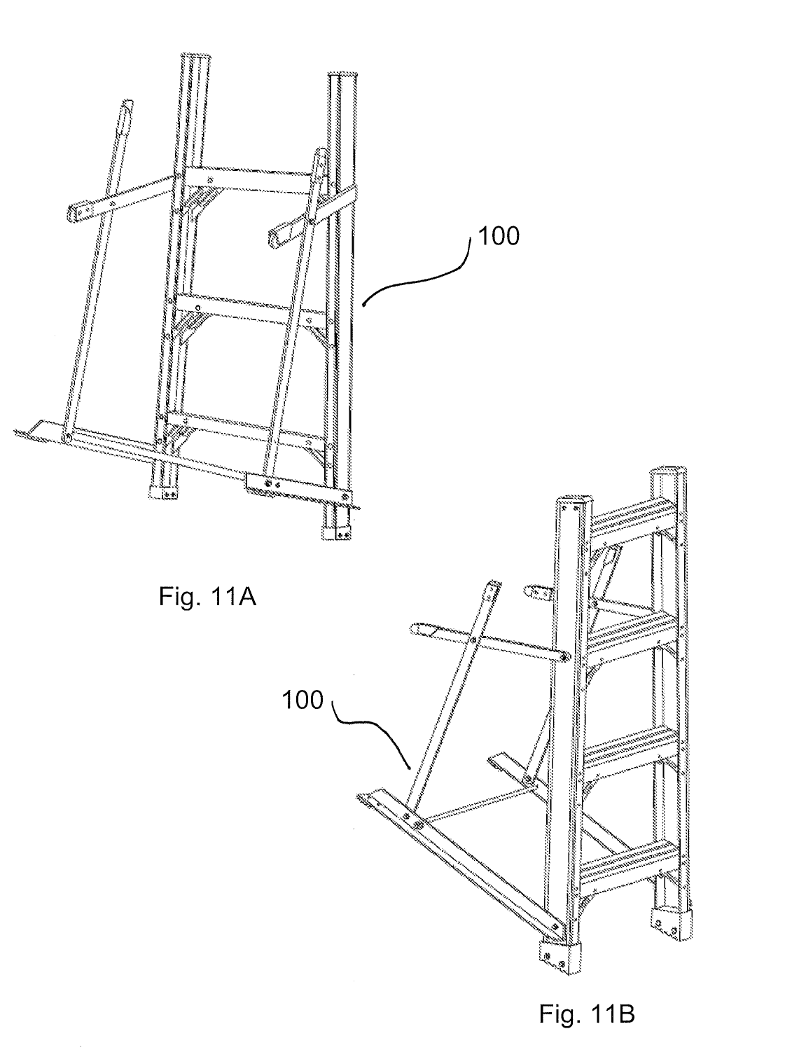

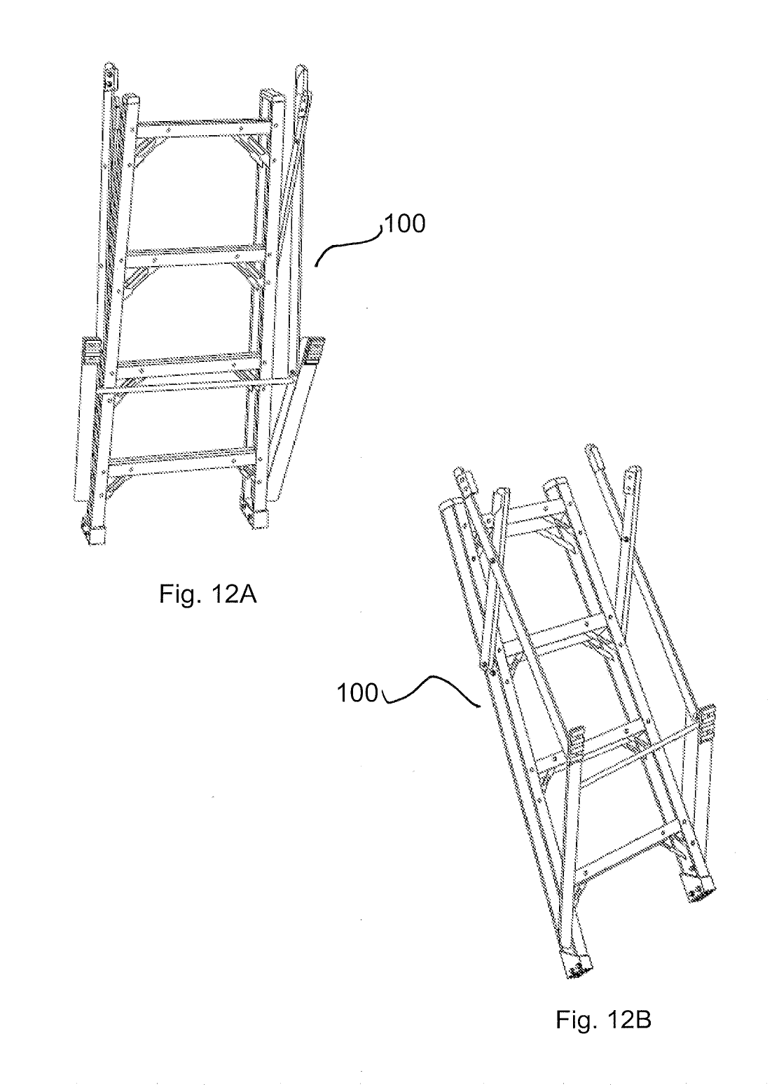

FIGS. 10 and 11 illustrate the collapsible ladder system 100 with the first brace and the second brace in a partially collapsed (partially folded) position. FIGS. 12 through 14 illustrate the various stages of collapse, with FIG. 12 being substantially collapsed.

As illustrated, the base rails 108a, 108b may be pivoted about a pivotable connector at pivot point A (FIG. 4). As further illustrated, the base rails 108a, 108b may comprise a support rod 124 disposed to lie generally perpendicular to said base rails 108a, 108b, effectively defining a base rail assembly. Thus, the base rail assembly may be pivoted towards the ladder rails 102a, 102b, thereby collapsing the collapsible ladder system 100. Review FIGS. 12 through 14 for additional views of the collapsible ladder system 100 in the substantially collapsed position. In some embodiments, a support rod may be used to connect both upper support braces or both lower support braces, wherein the support rod is disposed to lie generally perpendicular to the upper or lower support brace, co

The collapsible ladder system 100, and components thereof, as described can be constructed from any material known in the art of ladder fabrication, including but not limited to wood, metal, metal alloys, fiberglass, composites, carbon fiber, plastic or a combination thereof. Similarly, the rails need not be constructed from the same materials.

Further, the rails may be fabricated from a single, continuous material that requires fewer connection points (e.g., welds/joints), thereby decreasing costs while also strengthening the rails. For example, each rail may be constructed from a single length of metal or metal alloy which may be cut, molded or stamped in the shape of the desired rail. The collapsible ladder system 100 may also include a kick peg mounted on one or more of the collapsible ladder system 100's rails or other surface. The kick peg allows for easy employment of the ladder system because the user is able to spread the collapsible ladder system 100 using only a foot.

While the present invention has been described with respect to what are currently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation, so as to encompass all such modifications and equivalent structures and functions.

All U.S. and foreign patent documents, all articles, all brochures and all other published documents discussed above are hereby incorporated by reference into the Detailed Description of the Preferred Embodiment.

What is claimed is:

1. A collapsible ladder system comprising:
a first ladder rail and a second ladder rail connected by a plurality of rungs,
a base rail assembly comprising:
a first base rail pivotably connected to both the first ladder rail and a lower support brace, wherein the lower support brace is pivotably connected to an upper support brace that is pivotably connected to the first ladder rail;
a second base rail pivotably connected to both the second ladder rail and a lower support brace, wherein the lower support brace is pivotably connected to an upper support brace that is pivotably connected to the second ladder rail.

2. The collapsible ladder system of claim 1, wherein the base rail assembly is configured to collapse into a plane substantially parallel to a plane formed by the first and second ladder rails.

3. The collapsible ladder system of claim 1, wherein the base rail assembly further comprises a brace lock disposed on the upper or lower support brace, the brace lock configured to releasably engage the upper or lower support braces to inhibit the rotation about a point where the upper and lower support braces are connected.

4. The collapsible ladder system of claim 3, wherein the brace lock further comprises a sliding sleeve configured to inhibit the brace lock from disengaging.

5. The collapsible ladder system of claim 1, wherein the base rail assembly further comprises a support rod connected to the first and second base rails and disposed to lie substantially perpendicular to the first and second base rails.

6. The collapsible ladder system of claim 1, wherein the base rail assembly further comprises a gripping material connected to the first or second base rail.

7. A base rail assembly for a ladder comprising:
a first base rail pivotably connected a lower support brace that is pivotably connected to an upper support brace;
a second base rail pivotably connected a lower support brace that is pivotably connected to an upper support brace;
wherein the base rail assembly is pivotably connected to the ladder.

8. The base rail assembly of claim 7, wherein the base rail assembly is configured to collapse into a plane substantially parallel to a plane of the ladder.

9. The base rail assembly of claim 7, further comprising a brace lock disposed on the upper or lower support brace, the brace lock configured to releasably engage the upper or lower support braces to inhibit the rotation about a point where the upper and lower support braces are connected.

10. The collapsible ladder system of claim 9 wherein the brace lock further comprises a sliding sleeve configured to inhibit the brace lock from disengaging.

11. The base rail assembly of claim 7, further comprising a support rod connected to the first and second base rails and disposed to lie substantially perpendicular to the first and second base rails.

12. The base rail assembly of claim 7, further comprising a gripping material connected to the first or second base rail.

13. The base rail assembly of claim 7, wherein the base rail assembly is connected to a rail of the ladder through a plurality of pivotable connectors.

14. The base rail assembly of claim 7, wherein the base rail assembly is connected to the ladder through a pivotable connector disposed through the inside of one or more rungs of the ladder.

15. A method of securing a collapsible ladder system comprising:
(i) providing a collapsible ladder system comprising:
a first ladder rail and a second ladder rail connected by a plurality of rungs; and
a base rail assembly comprising:
a first base rail pivotably connected to both the first ladder rail and a lower support brace, wherein the lower support brace is pivotably connected to an upper support brace that is pivotably connected to the first ladder rail; and
a second base rail pivotably connected to both the second ladder rail and a lower support brace, wherein the lower support brace is pivotably connected to an upper support brace that is pivotably connected to the second ladder rail; and
(ii) pivoting the base rail assembly into a position wherein the first and second base rails are in substantial contact with the ground; and
(iii) securing the collapsible ladder system by engaging a brace lock disposed on the upper or lower support brace, the brace lock configured to releasably engage the upper or lower support braces to inhibit the rotation about a point where the upper and lower support braces are connected.

16. The method of claim 15, further comprising,
(iv) engaging a sliding sleeve configured to inhibit the brace lock from disengaging.
